(19) United States
(12) Patent Application Publication
(10) Pub. No.: US 2024/0238873 A1
(43) Pub. Date: Jul. 18, 2024

(54) SYSTEM AND METHOD FOR POSITIONING A 3D PART ON A BUILD PLATE

(71) Applicant: XEROX CORPORATION, Norwalk, CT (US)

(72) Inventor: Charles Buechel, Webster, NY (US)

(73) Assignee: XEROX CORPORATION, Norwalk, CT (US)

(21) Appl. No.: 18/155,916

(22) Filed: Jan. 18, 2023

(51) Int. Cl. B22F 10/85; B22F 10/31; B33Y 50/00

(52) U.S. Cl. CPC B22F 10/85; B22F 10/31; B33Y 50/00

(57) ABSTRACT

A method for printing a 3D part includes receiving a print plan for the 3D part. The method also includes scanning a build plate, onto which the 3D part will be printed, to produce a scan that comprises a topography of an upper surface of the build plate. The method also includes comparing the print plan and the scan. The method also includes determining a recommended position to print the 3D part on the build plate based at least partially upon the comparison.

### TECHNICAL FIELD

The present teachings relate generally to three-dimensional (3D) printing and, more particularly, to systems and methods for selecting where on a build plate to build (i.e., print) a 3D part based at least partially upon a topography of the build plate.

### BACKGROUND

Three-dimensional (3D) printing jets a liquid build material through an ejector. A plurality of drops of the liquid build material are ejected from a nozzle of the ejector. The drops fall onto a build plate where they cool and solidify to form a 3D part. For the best outcomes, the build plate should be flat. More particularly, the upper surface of the build plate, where the drops will land, should be free of defects such as warpage that may not be visible to the eye.

Laser scanners may provide a topographical image of the build plate; however, the operator then has to manually evaluate the topographical image to determine if the 3D part should be printed on the build plate, and/or where the 3D part should be printed on the build plate for the best results. Manual evaluation of the scan requires the operator to understand how to interpret the scan and what tolerances are acceptable for the 3D part being printed. Based on learned knowledge and experience, the operator then offsets the 3D part by manually entering coordinates.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A method for printing a 3D part is disclosed. The method includes receiving a print plan for the 3D part. The method also includes scanning a build plate, onto which the 3D part will be printed, to produce a scan that comprises a topography of an upper surface of the build plate. The method also includes comparing the print plan and the scan. The method also includes determining a recommended position to print the 3D part on the build plate based at least partially upon the comparison.

In another embodiment, the method includes receiving a print plan. The print plan includes a size and a shape of the 3D part, a size and a shape of supports, a planned position of the 3D part and the supports on a build plate, and a planned orientation of the 3D part and the supports on the build plate. The method also includes scanning the build plate. The build plate is scanned before a first layer of the 3D part and the supports is printed. Scanning the build plate produces a scan that includes a topography of an upper surface of the build plate including: a flat surface, an area that is vertically offset from the flat surface by greater than a predetermined threshold, and an interface between the flat surface and the area. The predetermined threshold is from about 0.05 mm and about 0.30 mm. The method also includes comparing the print plan and the scan. Comparing the print plan and the scan includes overlaying the print plan onto the scan with the 3D part and supports in the planned position on the build plate. The method also includes determining a recommended position of the 3D part and the supports on the build plate based at least partially upon the comparison. The recommended position is laterally-offset from the planned position. The recommended position of the 3D part is on the flat surface, the area, or both, but not on the interface. The method also includes determining a recommended orientation of the 3D part and the supports on the build plate based at least partially upon the comparison. The method also includes printing the 3D part and the supports in the recommended position and the recommended orientation on the build plate.

A 3D printer is also disclosed. The 3D printer includes an ejector configured to receive a build material. The ejector includes a nozzle. A plurality of drops of the build material are ejected through the nozzle in a liquid state. The 3D printer also includes a build plate positioned below the nozzle. The drops land on the build plate and cool and solidify thereon to form a 3D part. The 3D printer also includes a scanner configured to scan the build plate to produce a scan that includes a topography of an upper surface of the build plate. The 3D printer also includes a computing system configured to: receive a print plan for the 3D part; receive the scan; compare the print plan and the scan; and determine a recommended position to print the 3D part on the build plate based at least partially upon the comparison.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 depicts a schematic cross-sectional side view of a 3D printer, according to an embodiment.

FIG. 2 depicts a flowchart of a method for printing a 3D part using the 3D printer, according to an embodiment.

FIG. 3 depicts a schematic view of a print plan including the 3D part and supports, according to an embodiment.

FIG. 4 depicts a schematic view of a scan of a build plate of the 3D printer, according to an embodiment.

FIG. 5 depicts a schematic view of the print plan overlaid on the scan and in a default position, according to an embodiment.

FIG. 6 depicts a schematic view of another scan of the build plate, according to an embodiment.

FIGS. 7A and 7B depict schematic views of recommended positions of the 3D part and supports on the build plate, according to an embodiment.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

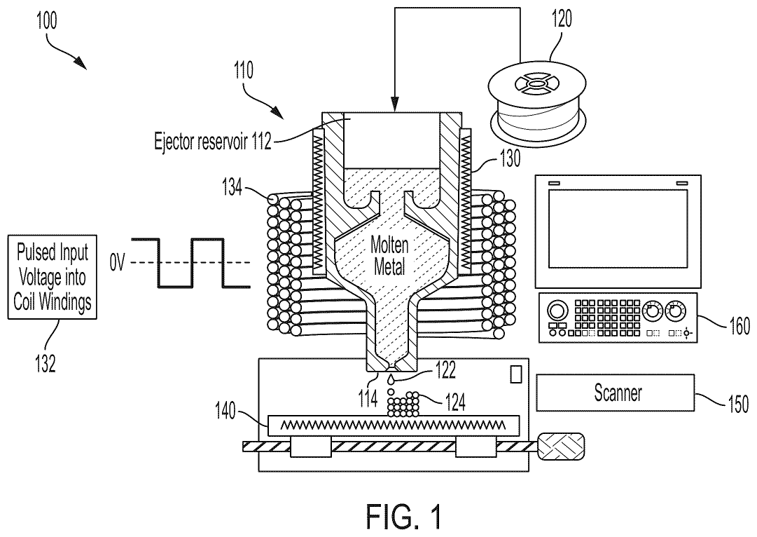

FIG. 1 depicts a schematic cross-sectional side view of a 3D printer 100, according to an embodiment. The printer 100 may include an ejector (also referred to as a pump) 110. As used herein, the ejector 110 refers to a structure that can be selectively activated to cause a build material 120 to be ejected from a nozzle 114 of the ejector 110. As used herein, the nozzle 114 refers to a physical structure from which the build material 120 begins flight.

The ejector 110 may define a reservoir (also referred to as an ejector reservoir) 112 that is configured to receive and/or store the build material 120 that is to be ejected from the nozzle 114. The build material 120 may be or include a metal, a polymer, or the like. In one embodiment, the build material 120 may be greater than about 50% metal, greater than 60% metal, greater than 70% metal, greater than 80% metal, greater than 90% metal, or about 100% metal (e.g., by volume and/or mass). For example, the build material 120 may be or include a spool of aluminum wire (e.g., 6061 aluminum). In another embodiment, the build material 120 may be or include copper or other metals.

The 3D printer 100 may also include one or more heating elements 130. The heating elements 130 are configured to melt the build material 120 within the ejector reservoir 112, thereby converting the build material 120 from the solid state to the liquid (e.g., molten) state within the ejector reservoir 112.

The 3D printer 100 may also include a power source 132 and one or more metallic coils 134. The metallic coils 134 are wrapped at least partially around the ejector 110 and/or the heating elements 130. The power source 132 may be coupled to the coils 134 and configured to provide power thereto. In one embodiment, the power source 132 may be configured to provide a step function direct current (DC) voltage profile (e.g., voltage pulses) to the coils 134, which may create an increasing magnetic field. The increasing magnetic field may cause an electromotive force within the ejector 110, that in turn causes an induced electrical current in the liquid build material 120. The magnetic field and the induced electrical current in the liquid build material 120 may create a radially inward force on the liquid build material 120, known as a Lorentz force. The Lorentz force creates a pressure at an inlet of the nozzle 114 of the ejector 110. The pressure causes the liquid build material 120 to be jetted through and/or ejected from the nozzle 114 in the form of one or more drops 122.

The 3D printer 100 may also include a build plate (also referred to as a substrate) 140 that is positioned below the nozzle 114. The drops 122 may be ejected from the nozzle 114 and subsequently land on the build plate 140 where they may cool and solidify to form a first (e.g., bottom) layer. Additional drops 122 may be jetted to form layer upon layer that eventually produces a 3D part 124. As mentioned above, the upper surface of the build plate 140 may have one or more areas that are not flat (e.g., warpages or defects). Printing the 3D part 124 onto an area of the build plate 140 that is not flat may cause the 3D part 124 to deviate from the planned design.

The 3D printer 100 may also include a scanner 150. The scanner 150 may be or include a laser scanner that is configured to scan the topography of the upper surface of the build plate 140.

The 3D printer 100 may also include a computing system 160. As described below, the computing system 160 may receive planned design of the 3D part 124 as well as the scan from the topography scanner 150. The computing system 160 may determine whether and/or where to print the 3D part 124 on the build plate 140 based at least partially upon the planned design and the scan. The computing system 160 may also or instead determine an orientation of (e.g., how to move/rotate) the 3D part 124 prior to printing based at least partially upon the planned design and the scan.

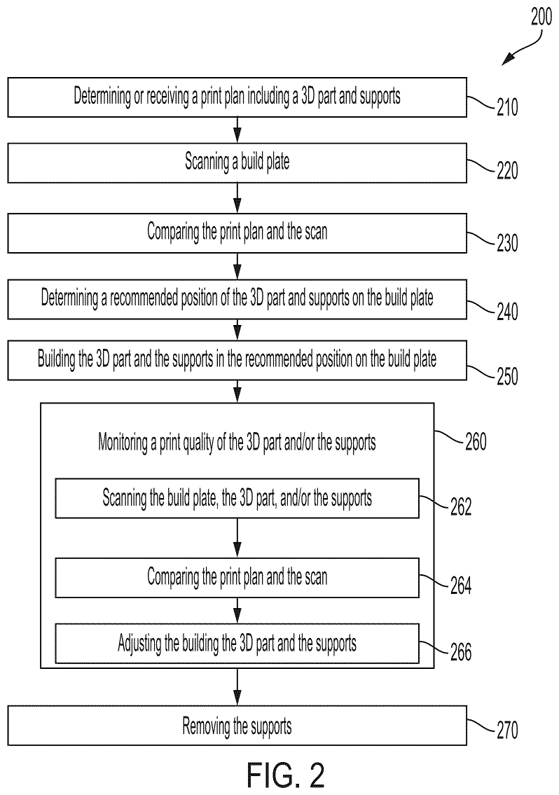

FIG. 2 depicts a flowchart of a method 200 for printing the 3D part 124, according to an embodiment. More particularly, the method 200 may determine (e.g., recommend) a position to print the 3D part 124 on the build plate 140. The method 200 may be performed by the 3D printer 100 (e.g., the computing system 160). An illustrative order of the method 200 is provided below; however, one or more steps of the method 200 may be performed in a different order, repeated, combined, or omitted.

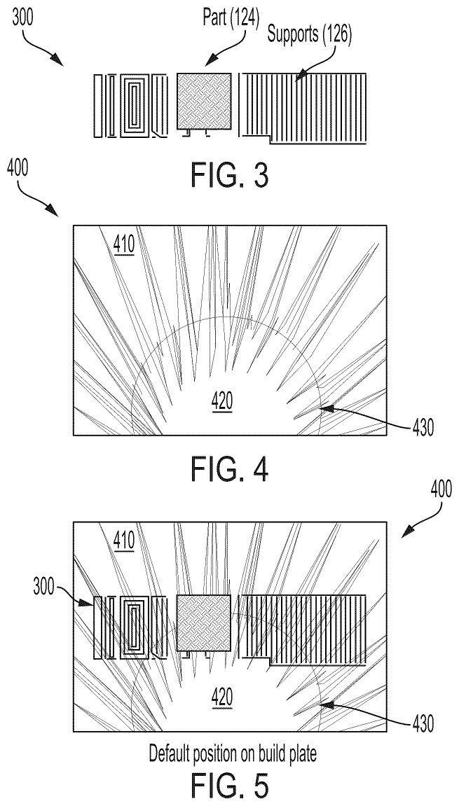

The method 200 may include determining or receiving a print plan, as at 210. FIG. 3 depicts a schematic view of a print plan 300 including the 3D part 124 and supports 126, according to an embodiment. The drops 122 may cool and solidify on the build plate 140 to form both the 3D part 124 and the supports 126. The supports 126 may be positioned at least partially between the build plate 140 and one or more portions of the 3D part 124. In an example, the portions of the 3D part 124 may be or include overhangs. After printing is completed, the supports 126 may be removed (e.g., machined away) to yield the 3D part 124. Thus, the supports 126 may be sacrificial.

In one embodiment, the print plan 300 may include the size and/or shape of the 3D part 124 and supports 126. The print plan 300 may also include also include a first (e.g., planned) position on the build plate 140 where the 3D part 124 and the supports 126 will be printed. The print plan 300 may also include a planned orientation of the 3D part 124 and the supports 126 on the build plate 140.

The method 200 may also include scanning the build plate 140, as at 220. FIG. 4 depicts a schematic view of a scan 400 of the build plate 140, according to an embodiment. The scan (also referred to as a first scan) 400 may be performed by the scanner 150 on the upper surface of the build plate 140 (e.g., before printing begins). The first scan 400 may show that the upper surface of the build plate 140 includes a substantially flat surface 410. As used herein, the term “flat” or “substantially flat” (e.g., flat surface) includes a vertical topography deviation that is less than a predetermined threshold. The predetermined threshold may be from about 0.05 mm to about 0.50 mm, about 0.05 mm to about 0.30 mm, or about 0.10 to about 0.20 mm (e.g., 0.15 mm). In one embodiment, the flat surface 410 may include greater than 10%, greater than 25%, greater than 50%, greater than 60%, greater than 70%, greater than 80%, or greater than 90% of the area of the upper surface of the build plate 140.

The first scan 400 may show that the upper surface of the build plate 140 also includes an area 420 that deviates (e.g., vertically) from the flat surface 410 by more than the predetermined threshold. Thus, the area 420 may not be (e.g., horizontally) aligned with the flat surface 410.

More particularly, the area 420 may be above and/or below the flat surface 410 by more than the predetermined threshold. In the example shown, the area 420 is parallel with the flat surface 410. In other embodiments, the area 420 may not be parallel. For example, the area 420 may be curved, uneven, or the like.

An interface 430 may exist between the flat surface 410 and the area 420. The interface 430 represents the (e.g., vertical) transition therebetween. Thus, the area 420, the interface 430, or the combination thereof may be convex (i.e., protrude upward) or concave (i.e., protrude downward) with respect to the flat surface 410. In an example, the area 420 and/or the interface 430 may protrude (e.g., in the vertical direction) by more than about 0.15 mm from the flat surface 410.

The method 200 may also include comparing the print plan 300 and the first scan 400, as at 230. For example, the print plan 300 may be combined with (e.g., overlaid upon) the first scan 400. FIG. 5 depicts a schematic view of the print plan 300 overlaid upon the first scan 400, according to an embodiment. More particularly, FIG. 5 depicts a first (e.g., default or planned) position of the 3D part 124 and the supports 126 on the build plate 140 (e.g., based upon the print plan 300). As shown in FIG. 5, a portion of the 3D part 124 is initially planned to be printed on the interface 430. Printing the 3D part 124 on the interface 430 may cause the 3D part 124 to deviate from the planned design.

The method 200 may also include determining a second (e.g., recommended and/or actual) position of the 3D part 124 and supports 126 on the build plate 140, as at 240. As mentioned above, the computing system 160 may determine the second position based at least partially upon the print plan 300, the first scan 400, the comparison, or a combination thereof. The second position may be a lateral translation in the horizontal (e.g., X-Y) plane on the build plate 140 from the first position. The second position may also or instead include an orientation change (e.g., a rotation) from the first position.

In an embodiment, the second position may be determined based at least partially upon the first position. For example, when the 3D part 124 is sliced for printing, it may be pre-positioned on the X-Y coordinates on the build plate 140, or the first position may default to the center of the build plate 140. The initial coordinates for the 3D part 124 and supports 126 may be utilized by the computing system 160 to determine the required offsets and/or rotation of the 3D part 124 and supports 126 based upon the print plan 300, the first scan 400, the comparison, and/or the acceptable tolerances.

In another embodiment, the second position may be determined based at least partially upon the X-Y coordinates of the supports 126 versus the 3D part 124. More particularly, the supports 126 may be printed to support overhangs of the 3D part 124. Although it may be optimal to have the supports 126 printed over a flat area of the build plate 140, it is not required as they may be removed during post-printing processing (e.g., machining). As discussed below, the first layer of the 3D part 124 may be analyzed and compared to the build plate health. The finished 3D part 124 may take priority placement over the supports 126. The method 200 may consider the positioning of the 3D part 124 and the supports 126 independently for optimal X-Y placement and rotation of both parts.

In another embodiment, the second position may be determined based at least partially upon the identification of the build plate 140. The computing system 160 may know the specific build plate 140 being used (e.g., not the part number but the actual build plate) so that it may analyze the history of the build plate 140 and previous 3D parts printed thereon.

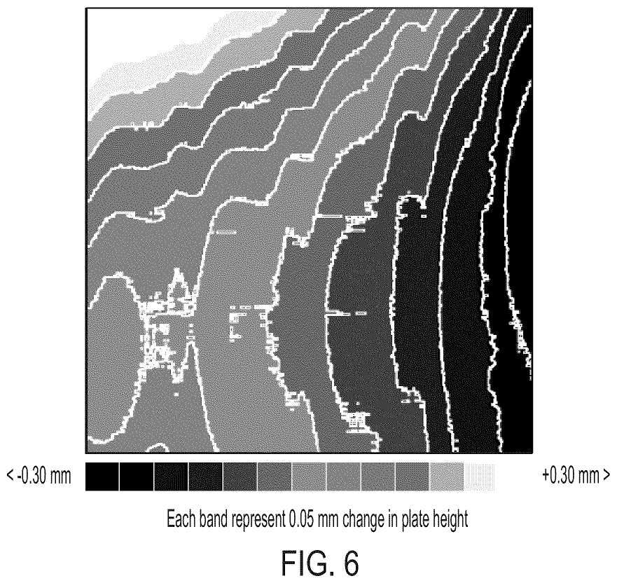

In another embodiment, the second position may be determined based at least partially upon the build plate warpage topographical tolerance. FIG. 6 depicts a schematic view of another scan of the build plate 140, according to an embodiment. By default, the printing job may be recommended to be printed within a predetermined topography deviation (e.g., 0.15 mm or less). The topography deviation refers to the vertical distance from the flat surface 410 of the build plate 140. The tolerance level may be evaluated and modified to use more or less of the build plate surface area when determining the second position.

In another embodiment, the second position may be determined based at least partially upon prior X-Y printed coordinates. More particularly, the computing system 160 may analyze the printing of previous 3D parts on the build plate 140 to select areas that have not been overly used for printing. As used herein, “overly used” refers to a location where fewer than a predetermined number of 3D parts (e.g., three 3D parts) and/or supports have been printed. Although the warpage of the build plate 140 can change from print-to-print (e.g., due to thermal shock), the actual surface of the build plate 140 can also degrade over time. Based on the size of the job (e.g., the printing of the 3D part 124 and supports 126), multiple areas of the build plate 140 may be acceptable. However, the computing system 160 may select for the second position an area of the build plate 140 that has been utilized the least for printing.

In another embodiment, the second position may be determined based at least partially upon a print optimization. As described below, the computing system 160 may perform a print optimization based on scans of one or more layers of the 3D part 124 and/or supports 126 during printing. The computing system 140 may consider corrections made to the first several layers along with the build plate topography to determine if adjustments to acceptable build plate warpage tolerances should be made for the current print job or future print jobs.

In another embodiment, the second position may be determined based at least partially upon the material (e.g., alloy) being used as the build material 120. Different materials may have different properties that may impact the acceptable tolerance of build plate health and therefore the positioning of the 3D part 124 on the build plate 140.

In another embodiment, the second position may be determined based at least partially upon the print quality settings. When the job is sliced, print quality settings may be applied. Higher or lower quality print settings may impact acceptable build plate topographical tolerances. The computing system 160 may take this into consideration when it determines the second position of the 3D part 124 and/or supports 126 on the build plate.

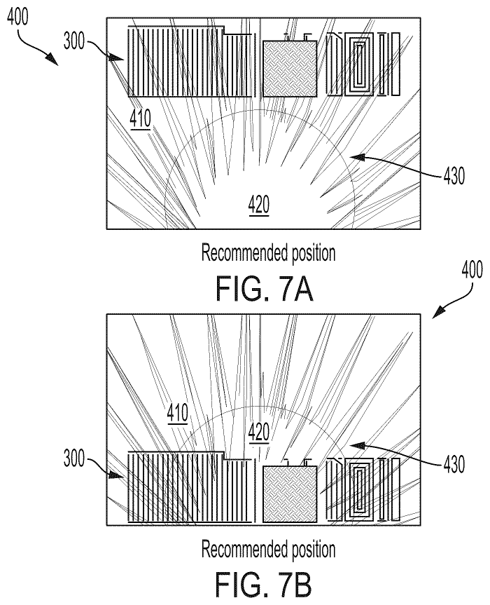

FIGS. 7A and 7B depict schematic views of second (e.g., recommended) positions of the 3D part 124 and supports 126 on the build plate 140, according to an embodiment. More particularly, FIG. 7A shows the 3D part 124 and supports 126 printed on the flat surface 410 (e.g., outside of the area 420 and interface 430). In another embodiment, the 3D part 124 may be printed outside the area 420, and the supports 126 may be printed on the area 420 and/or the interface 430. FIG. 7B shows the 3D part 124 printed on the area 420 and the supports 126 printed on the area 420 and/or the interface 430. In these examples, the first scan 400 shows that, while the area 420 has a different depth than the flat surface 410, the area 420 itself is also substantially flat. As such, the 3D part 124 may be printed on the area 420.

Referring back to FIG. 2, the method 200 may also include building (e.g., printing) the 3D part 124 and the supports 126 in the second position on the build plate 140, as at 250. Printing in/on the second position (as opposed to the first position) may reduce the printing time, the amount of build material 120 used, and the amount of machining required after printing because additional time, build material 120, and machining are required to offset the depth variations when printing on the interface 430.

The method 200 may also include monitoring a print quality of the 3D part 124 and/or the supports 126, as at 260. The print quality may be monitored during printing (e.g., after a first layer is printed and before a second layer is printed) or after printing is complete. More particularly, monitoring the print quality may include scanning the build plate 140, the 3D part 124, the supports 126, or a combination thereof, as at 262. This may include a different scan (also referred to as second scans) after each layer is printed. For example, a second scan may be performed by the scanner 150 on the upper surface of the first layer of the 3D part 124 and/or supports 126.

Monitoring the print quality may also include comparing the print plan 300 and the second scan(s), as at 264. In other words, the printed portion (e.g., layer) of the actual 3D part 124 and/or the supports 126 may be compared to the corresponding portion of the 3D part 124 and/or the supports 126 in the print plan 300. This may include determining a deviation (e.g., difference) between the printed portion and the corresponding portion in the print plan 300. The deviation may be between the printed and planned shapes, the printed and planned sizes, the printed and planned print times, the printed and planned amount of build material used, the printed and planned machining required, or a combination thereof.

Monitoring the print quality may also include adjusting the building (e.g., printing) the 3D part 124 and the supports 126, as at 266. The adjustment may be in response to the comparison. For example, in response to the upper surface of the (e.g., first) layer of the 3D part 124 and/or the supports 126 not being flat or otherwise deviating from the print plan 300 by more than a predetermined amount, adjusting the building may include depositing more or less build material 120 than planned in the non-flat X-Y location to make the upper surface of the next layer flat in that X-Y location. The print quality may also or instead be used to determine whether (e.g., how much) the recommended second position improved the parameters (e.g., size, shape, print time, build material, machining, etc.) when compared to the first position. This information may be used to calibrate the method 200 to adjust recommendations for the second position to improve the printing of future 3D parts.

The method 200 may also including removing the supports 126, as at 270. The supports 270 may be removed after printing is complete. As mentioned above, the supports 270 may be machined away to yield only the 3D part 124.

The method 200 may be automated to reduce the print time and reliance on human evaluation and error. It also reduces post-print processing (e.g., machining) by ensuring that the layers (e.g., the first layer) of the 3D part 124 is flat. In contrast, conventional technologies address compensating for build plate defects by altering the amount of build material deposited on the build plate. The system and method described herein improve upon this by automatically positioning the 3D part 124 in different (e.g., best) location on the build plate 140. This may reduce material waste, reduce the need for programmatic adjustments while printing, reduce post-print machining of the bottom layer, and improve removal from the build plate surface.

Notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” may include any and all sub-ranges between (and including) the minimum value of zero and the maximum value of 10, that is, any and all sub-ranges having a minimum value of equal to or greater than zero and a maximum value of equal to or less than 10, e.g., 1 to 5.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified.

Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A method for printing a 3D part, the method comprising:
receiving a print plan for the 3D part;
scanning a build plate, onto which the 3D part will be printed, to produce a scan that comprises a topography of an upper surface of the build plate;
comparing the print plan and the scan; and
determining a recommended position to print the 3D part on the build plate based at least partially upon the comparison.

2. The method of claim 1, wherein the print plan comprises a planned position of the 3D part on the build plate.

3. The method of claim 2, wherein the recommended position is laterally-offset from the planned position.

4. The method of claim 1, wherein build plate is scanned before a first layer of the 3D part is printed.

5. The method of claim 1, wherein the topography of the upper surface of the build plate comprises:
a flat surface;
an area that is vertically offset from the flat surface by greater than a predetermined threshold; and
an interface between the flat surface and the area.

6. The method of claim 5, wherein the recommended position of the 3D part is on the flat surface but not on the interface.

7. The method of claim 5, wherein the flat surface and the area are both substantially flat, and wherein the interface is not substantially flat.

8. The method of claim 7, wherein the recommended position of the 3D part is on the area but not on the interface.

9. The method of claim 1, further comprising determining a recommended position to print supports on the build plate based at least partially upon the comparison, wherein the recommended position of the supports is at least partially on the interface.

10. The method of claim 1, further comprising printing the 3D part in the recommended position on the build plate.

11. A method for printing a 3D part, the method comprising:
receiving a print plan, wherein the print plan comprises:
a size and a shape of the 3D part;
a size and a shape of supports;
a planned position of the 3D part and the supports on a build plate; and
a planned orientation of the 3D part and the supports on the build plate;
scanning the build plate, wherein the build plate is scanned before a first layer of the 3D part and the supports is printed, and wherein scanning the build plate produces a scan that comprises a topography of an upper surface of the build plate including:
a flat surface;
an area that is vertically offset from the flat surface by greater than a predetermined threshold, wherein the predetermined threshold is from about 0.05 mm and about 0.30 mm; and
an interface between the flat surface and the area;
comparing the print plan and the scan, wherein comparing the print plan and the scan comprises overlaying the print plan onto the scan with the 3D part and supports in the planned position on the build plate;
determining a recommended position of the 3D part and the supports on the build plate based at least partially upon the comparison, wherein the recommended position is laterally-offset from the planned position, and wherein the recommended position of the 3D part is on the flat surface, the area, or both, but not on the interface;
determining a recommended orientation of the 3D part and the supports on the build plate based at least partially upon the comparison; and
printing the 3D part and the supports in the recommended position and the recommended orientation on the build plate.

12. The method of claim 11, further comprising scanning an upper surface of the first layer of the 3D part and the supports to produce a second scan.

13. The method of claim 12, further comprising comparing the print plan and the second scan to determine a deviation between parameters of the first layer and a corresponding planned first layer in the print plan.

14. The method of claim 13, wherein the parameters comprise the size of the 3D part and the supports, the shape of the 3D part and the supports, a time to print the 3D part and the supports, an amount of build material used to print the 3D part and the supports, and an amount of machining required to remove the supports.

15. The method of claim 14, further comprising adjusting the printing of the 3D part and the supports in response to the comparison of the print plan and the second scan to reduce the deviation for subsequent layers of the 3D part and the supports.

16. A 3D printer, comprising:
an ejector configured to receive a build material, wherein the ejector comprises a nozzle, and wherein a plurality of drops of the build material are ejected through the nozzle in a liquid state;
a build plate positioned below the nozzle, wherein the drops land on the build plate and cool and solidify thereon to form a 3D part
a scanner configured to scan the build plate to produce a scan that comprises a topography of an upper surface of the build plate; and
a computing system configured to:
receive a print plan for the 3D part;
receive the scan;
compare the print plan and the scan; and
determine a recommended position to print the 3D part on the build plate based at least partially upon the comparison.

17. The 3D printer of claim 16, wherein the build material comprises a metal.

18. The 3D printer of claim 16, wherein the print plan comprises a planned position of the 3D part on the build plate, and wherein the recommended position is laterally-offset from the planned position.

19. The 3D printer of claim 16, wherein the topography of the upper surface of the build plate comprises:
a flat surface;
an area that is vertically offset from the flat surface by greater than a predetermined threshold; and
an interface between the flat surface and the area.

20. The 3D printer of claim 19, wherein the recommended position is on the flat surface.
